(19) United States
(12) Patent Application Publication
(10) Pub. No.: US 2023/0232418 A1
(43) Pub. Date: Jul. 20, 2023

(54) PIGGYBACKING DOWNLINK CONTROL INFORMATION (DCI) FOR SEMI-PERSISTENT SCHEDULING

(71) Applicant: QUALCOMM Incorporated, San Diego, CA (US)

(72) Inventors: Yisheng XUE, San Diego, CA (US); Olufunmilola Omolade AWONIYI-OTERI, San Diego, CA (US); Jing SUN, San Diego, CA (US); Xiaoxia ZHANG, San Diego, CA (US); Mostafa KHOSHNEVISAN, San Diego, CA (US); Iyab Issam SAKHNINI, San Diego, CA (US); Chih-Hao LIU, San Diego, CA (US); Ozcan OZTURK, San Diego, CA (US); Changlong XU, Beijing (CN); Jelena DAMNJANOVIC, Del Mar, CA (US); Tao LUO, San Diego, CA (US); Yan ZHOU, San Diego, CA (US); Arumugam CHENDAMARAI KANNAN, San Diego, CA (US); Sony AKKARAKARAN, Poway, CA (US); Junyi LI, Fairless Hills, PA (US)

(21) Appl. No.: 17/995,537

(22) PCT Filed: May 14, 2020
(86) PCT No.: PCT/CN2020/090201

§ 371 Date: Oct. 5, 2022

(51) Int. Cl. H04W 72/232; H04W 72/11; H04L 1/1607

(52) U.S. Cl. CPC H04W 72/232; H04W 72/11; H04L 1/1671

(57) ABSTRACT

Wireless communications systems and methods related to piggybacking opportunities for communicating downlink control information (DCI) in a semi-persistent scheduling (SPS) configuration are provided. A first wireless communication device determines a piggybacking opportunity for communicating downlink control information (DCI) in a semi-persistent scheduling (SPS) configuration. The first wireless communication device communicates, with a second wireless communication device, a first communication based on the determined piggybacking opportunity.

### TECHNICAL FIELD

This application relates to wireless communication systems, including piggybacking opportunities for communicating downlink control information (DCI) in a semi-persistent scheduling (SPS) configuration.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

Semi-persistent scheduling (SPS) can be configured on a downlink shared channel to support periodic downlink transmissions. SPS can avoid usage of the downlink control channel because periodic transmissions may be configured for SPS as opposed to dynamically scheduling separate transmissions using downlink control information (DCI) communicated on the downlink control channel. However, SPS activation and changes to the SPS configuration may be communicated to the UE via downlink control information (DCI) on a downlink control channel, which can increase downlink control channel usage in a scenario with a large number of UEs that each have a SPS configuration.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication includes determining, by a first wireless communication device, a piggybacking opportunity for communicating downlink control information (DCI) in a semi-persistent scheduling (SPS) configuration, and communicating, by the first wireless communication device with a second wireless communication device, a first communication based on the determined piggybacking opportunity.

In an additional aspect of the disclosure, a first wireless communication device comprises a processor configured to determine a piggybacking opportunity for communicating DCI in a SPS configuration, and a transceiver configured to communicate, with a second wireless communication device, a first communication based on the determined piggybacking opportunity.

In an additional aspect of the disclosure, a non-transitory computer-readable medium having program code recorded thereon, the program code, when executed by a processor in a first wireless communication device, comprising code for causing the first wireless communication device to determine a piggybacking opportunity for communicating DCI in a SPS configuration, and communicate, with a second wireless communication device, a first communication based on the determined piggybacking opportunity.

In an additional aspect of the disclosure, a first wireless communication device comprises means for determining a piggybacking opportunity for communicating DCI in a SPS configuration, and means for communicating, with a second wireless communication device, a first communication based on the determined piggybacking opportunity.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some aspects of the present disclosure.

FIG. 2A is a timing diagram illustrating a transmission frame structure according to some aspects of the present disclosure.

FIG. 2B illustrates a hybrid automatic repeat request (HARQ) communication scenario according to some aspects of the present disclosure.

FIG. 2C illustrates a multi-component carrier (multi-CC) communication scheme according to some aspects of the present disclosure.

FIG. 3 illustrates a multi-CC, semi-persistent scheduling (SPS) communication scheme according to some aspects of the present disclosure.

FIG. 4 is a block diagram of a user equipment (UE) according to some aspects of the present disclosure.

FIG. 5 is a block diagram of an exemplary base station (BS) according to some aspects of the present disclosure.

FIG. 6 illustrates a SPS communication scenario according to some aspects of the present disclosure.

FIG. 7 illustrates a SPS communication scenario according to some aspects of the present disclosure.

FIG. 8 illustrates a SPS communication scenario according to some aspects of the present disclosure.

FIG. 9 illustrates a SPS communication scenario according to some aspects of the present disclosure.

FIG. 10 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive internet of things (IoTs) with a ultra-high density (e.g., ˜1M nodes/km²), ultra-low complexity (e.g., ˜10 s of bits/sec), ultra-low energy (e.g., ˜10+years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

Semi-persistent scheduling (SPS) can be configured on a physical downlink shared channel (PDSCH) to support periodic downlink transmissions. SPS activation, SPS reactivation, reconfiguration or changes to the SPS configuration, and other information related to the SPS configuration may be communicated to the UE via downlink control information (DCI) on a physical downlink control channel (PDCCH). For instance, the SPS configuration may be changed after becoming mis-matched with the changing operating environment over a period of time. Mis-matched SPS configurations may lead to an increasing number of dynamic grant retransmissions and/or SPS reactivations that each utilize PDCCH resources. Further, in a scenario with a large number of UEs with SPS configurations, the SPS-related DCI may utilize a corresponding larger amount of PDCCH resources.

The present application describes mechanisms for piggybacking various types of DCI related to the SPS configuration on a SPS PDSCH transmission. For example, DCI regarding activating, reactivating, reconfiguring, or otherwise changing the SPS configuration may be piggybacked on a SPS PDSCH (i.e., piggybacked in the SPS configuration on PDSCH). In some aspects, DCI related to the SPS configuration—such as the modulation and coding scheme (MCS), zero-power channel state information reference signal (ZP-CSI-RS) indicator, transmit power control (TPC), and physical uplink control channel (PUCCH) resource indicator (PRI) for communicating acknowledgements and negative acknowledgments (ACK/NACKs) related to the SPS PDSCH—may be piggybacked on a SPS PDSCH transmission. In some aspects, information related to the retransmission of SPS PDSCH data, such as hybrid automatic repeat request (HARQ) identifiers (IDs), redundancy version (RV) information, and new data indicators (NDIs), may be piggybacked on a SPS PDSCH. In some aspects, information regarding a group ACK codebook for early communication of SPS HARQ responses may be piggybacked on a SPS PDSCH transmission.

Aspects of the present disclosure can provide several benefits. For instance, the present disclosure includes communicating DCI related to the SPS configuration on the PDSCH, which beneficially avoids using PDCCH resources that can instead be utilized for dynamic grants or communicating other DCI to UEs. Moreover, piggybacking on SPS PDSCHs provides power savings to the UEs of the network, as the UEs can avoid monitoring or blind decoding PDCCHs for DCI. Additionally, the present disclosure includes configuring SPS retransmissions in the SPS PDSCHs, which beneficially avoids using PDCCH-based dynamic grants for retransmissions. Further, the present disclosure includes configuring a group ACK codebook for early communication of SPS HARQ responses, which beneficially allows the BS to receive an ACK/NACK early from the UE such that, in the case of an ACK, the HARQ process may be used to transmit new data. Utilizing a group ACK codebook also beneficially reduces overhead associated with HARQ responses by configuring the UE to transmit a group of responses at a time. The present disclosure therefore improves UE and network performance as to downlink and HARQ-based communications, beneficially providing higher data rates, higher capacity, better spectral efficiency, and increased reliability.

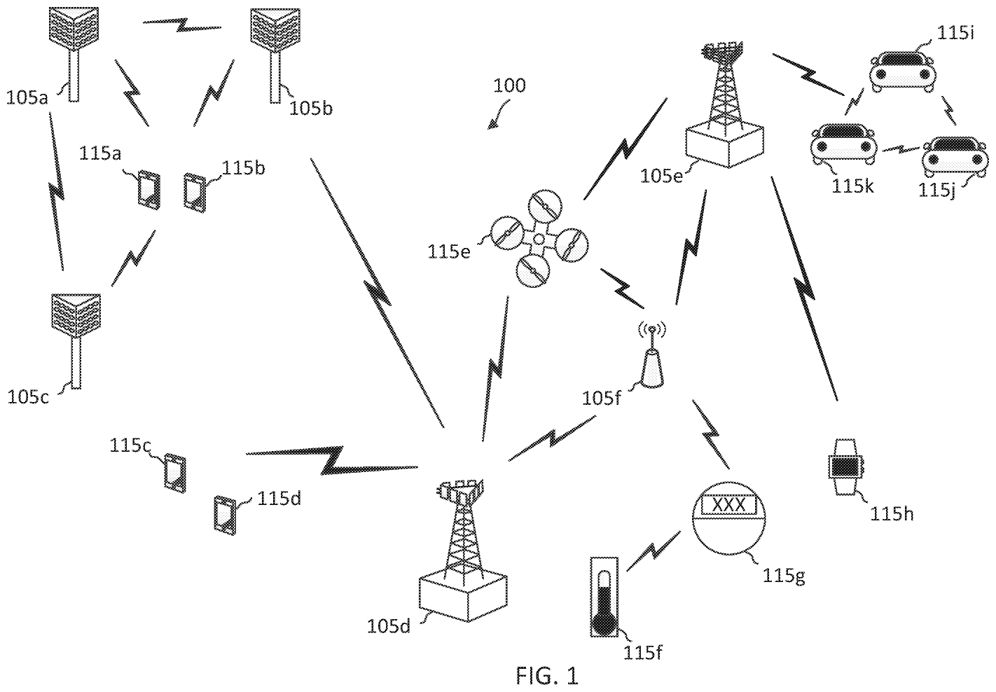

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

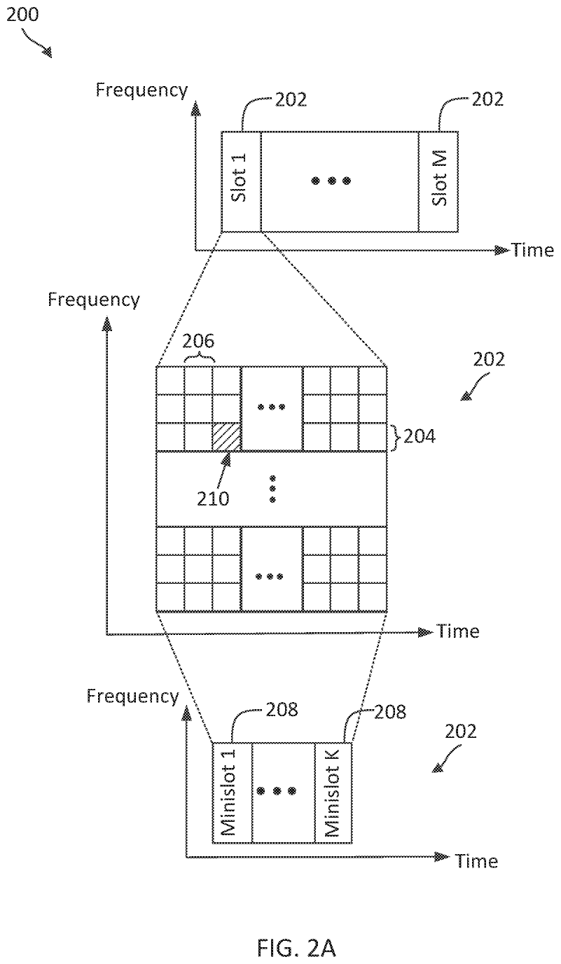

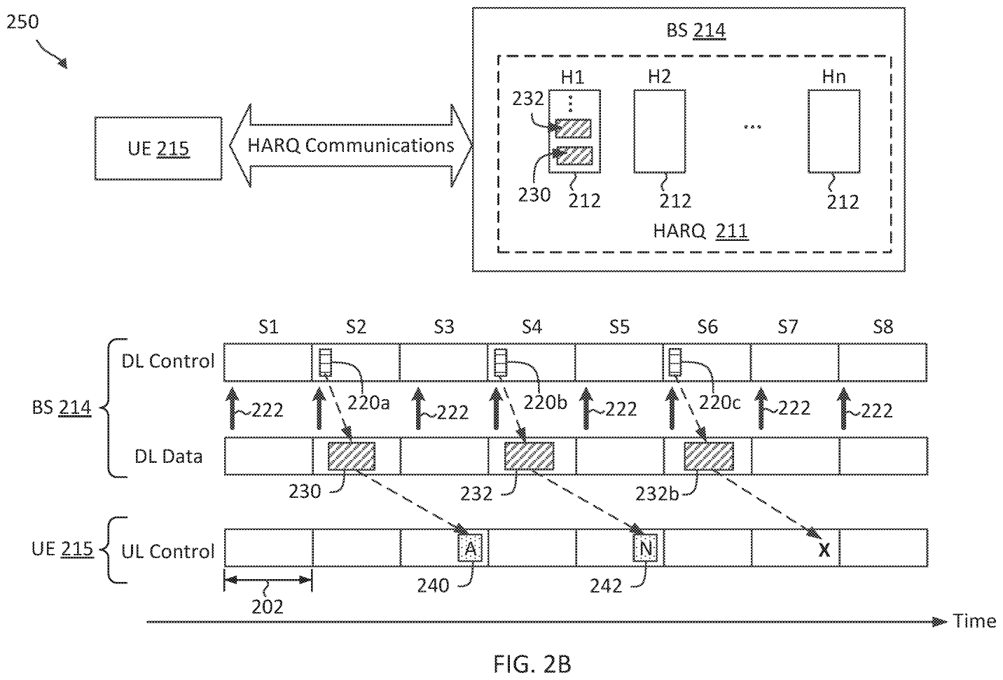

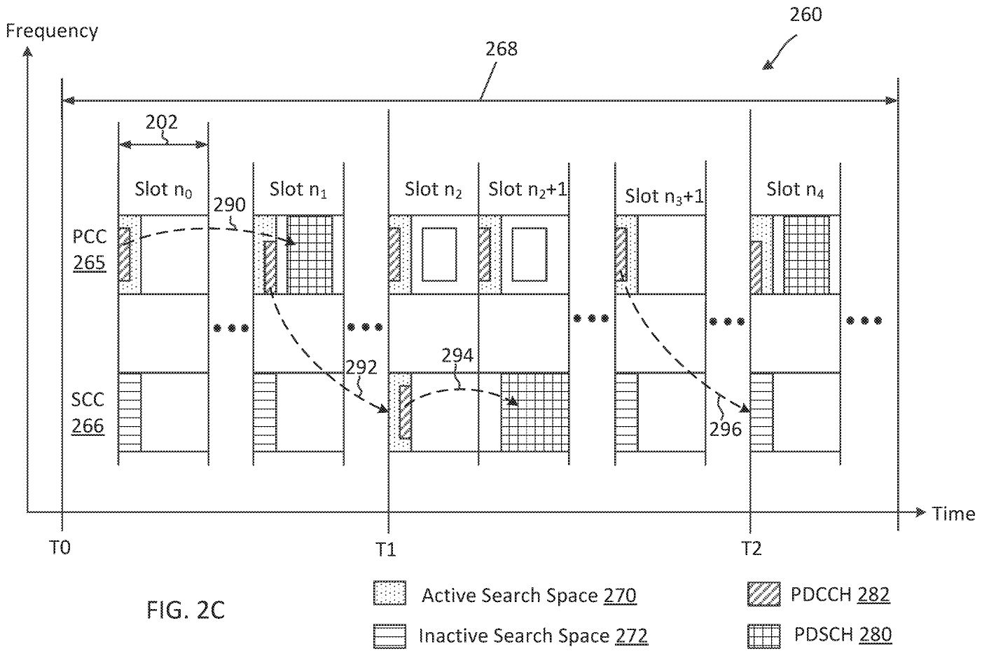

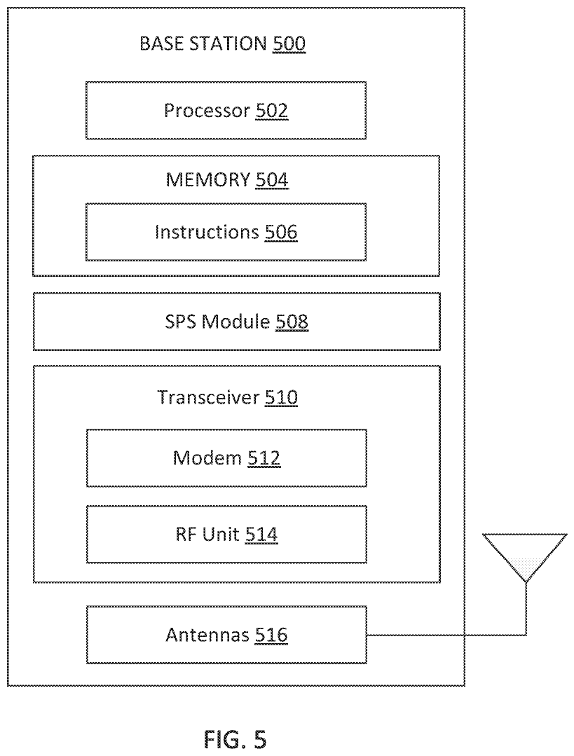

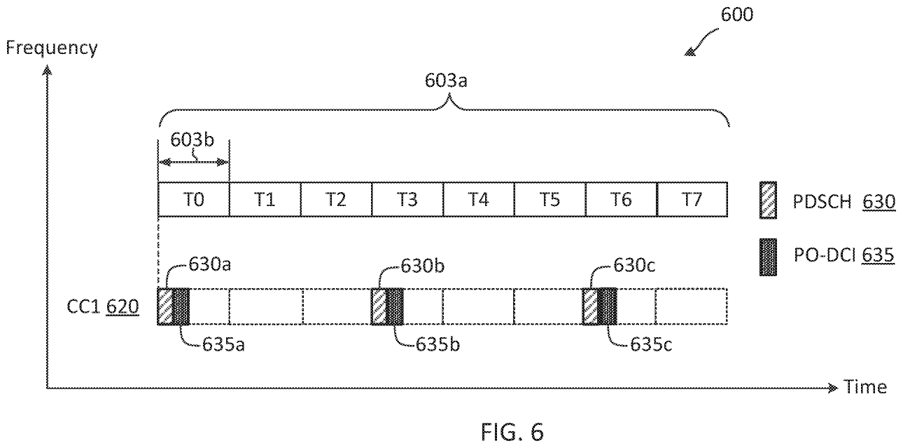

In some aspects, the network 100 may include a BS 105 (or, e.g., BS 214 of FIG. 2B, BS 500 of FIG. 6) and UE 115 (or, e.g., US 215 of FIG. 2B, UE 400 of FIG. 5) communicating downlink information in a SPS configuration. In some aspects, the network 100 and/or BS 105 may configure a SPS configuration with periodic PDSCH transmissions and retransmissions from BS 105 to UE 115. In some aspects, the BS 105 and UE 115 may also communicate via PDCCH, PUCCH, and PUSCH channels, among others. In some aspects, the UE 115 may communicate to the BS 105 acknowledgements or negative acknowledgements on PUCCHs regarding whether or not the UE received the SPS PDSCH transmissions. In some aspects, the network 100 and/or BS 105 may configure the UE 115 to communicate, to the BS 105, DCIs regarding the SPS configuration (e.g., reactivation, MCS, TPC, ZP-CSI-RS trigger) by piggybacking the DCIs on SPS PDSCHs.

FIG. 2A is a timing diagram illustrating a transmission frame structure 200 according to some embodiments of the present disclosure. The transmission frame structure 200 may be employed by BSs such as the BSs 105 and UEs such as the UEs 115 in a network such as the network 100 for communications. In particular, the BS may communicate with the UE using time-frequency resources configured as shown in the transmission frame structure 200. In FIG. 2A, the x-axes represent time in some arbitrary units and the y-axes represent frequency in some arbitrary units. The transmission frame structure 200 includes a radio frame 201. The duration of the radio frame 201 may vary depending on the embodiments. In an example, the radio frame 201 may have a duration of about ten milliseconds. The radio frame 201 includes M number of slots 202, where M may be any suitable positive integer. In an example, M may be about 10.

Each slot 202 includes a number of subcarriers 204 in frequency and a number of symbols 206 in time. The number of subcarriers 204 and/or the number of symbols 206 in a slot 202 may vary depending on the embodiments, for example, based on the channel bandwidth, the subcarrier spacing (SCS), and/or the CP mode. One subcarrier 204 in frequency and one symbol 206 in time forms one resource element (RE) 210 for transmission.

A BS (e.g., BS 105 in FIG. 1) may schedule a UE (e.g., UE 115 in FIG. 1) for UL and/or DL communications at a time-granularity of slots 202 or mini-slots 208. Each slot 202 may be time-partitioned into K number of mini-slots 208. Each mini-slot 208 may include one or more symbols 206. The mini-slots 208 in a slot 202 may have variable lengths. For example, when a slot 202 includes N number of symbols 206, a mini-slot 208 may have a length between one symbol 206 and (N−1) symbols 206. In some embodiments, a mini-slot 208 may have a length of about two symbols 206, about four symbols 206, or about seven symbols 206.

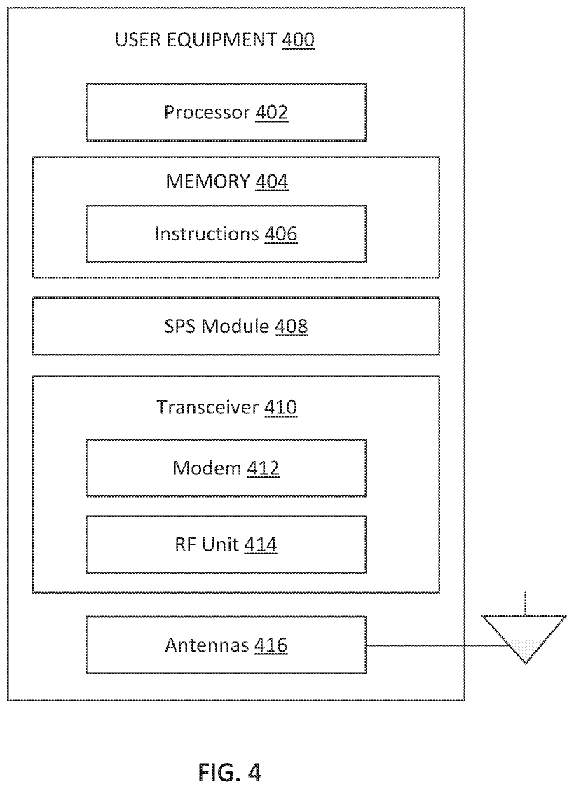

FIG. 2B illustrates a hybrid automatic repeat request (HARQ) communication scenario according to some aspects of the present disclosure. The functionality of scenario 250 can be executed by a computing device (e.g., a processor, processing circuit, and/or other suitable component) of a wireless communication device or other suitable means. The scenario 250 may correspond to a HARQ communication scenario in the network 100. In some aspects, a wireless communication device such as the UE 115, UE 215 of FIG. 2B, or UE 400 of FIG. 4 may utilize one or more components, such as the processor 402, the memory 404, the SPS module 408, the transceiver 410, the modem 412, and the one or more antennas 416, to execute the steps of scenario 250. Further, a wireless communication device such as the base station (BS) 105, BS 214 of FIG. 2B, or BS 500 of FIG. 5 may utilize one or more components, such as the processor 502, the memory 504, the SPS module 508, the transceiver 510, the modem 512, and the one or more antennas 516, to execute the steps of scenario 200. The scenario 250 may employ similar mechanisms as described in FIGS. 1-2A and 2C-10. In FIG. 2B, the x-axis represents time in some arbitrary units. The scenario 250 is described using a substantially similar transmission frame structure as FIG. 2A and may use the same reference numerals as in FIG. 2A for simplicity sake

In the scenario 250, a BS 214 (or, e.g., BSs 105, BS 500 of FIG. 5) may communicate DL data with a UE 215 (or, e.g., UEs 115, UE 400 of FIG. 4) using HARQ. For HARQ communications, a transmitting node (e.g., the BS 214) may transmit data to a receiving node (e.g., the BS 214). The receiving node may provide the transmitting node with a feedback on the reception status of the data. For example, the receiving node may transmit an ACK to the transmitting node to indicate a successful decoding of the data. Conversely, the receiving node may transmit a NACK to the transmitting node to indicate a decoding failure for the data. When the transmitting node receives an ACK from the receiving node, the transmitting node may transmit new data in a subsequent transmission. However, when the transmitting node receives a NACK from the receiving node, the transmitting node may retransmit the same data to the receiving node. In some aspects, the transmitting node may transmit the same encoding version of the data in the initial transmission and the retransmission. In some aspects, the transmitting node may transmit different encoding versions of the data in the initial transmission and the retransmission. In some aspects, the receiving node may apply soft-combining to combine the encoded data received from the initial transmission and the retransmission for decoding. For simplicity of discussion and illustration, FIG. 2B illustrates the HARQ communication in the context of DL data communications, though similar HARQ mechanisms may be applied to UL data communications.

In an example, the BS 214 includes a HARQ component 211. The HARQ component 211 is configured to perform multiple parallel HARQ processes 212 for DL data communications. The HARQ processes 212 may operate independent of each other. In other words, the ACKs, NACKs, and/or retransmissions are determined and processed separately for each HARQ process at the BS 214 and at the UE 215. Each HARQ process 212 may be identified by a HARQ process ID. For example, the HARQ processes 212 may be identified by identifiers H1, H2, Hn. The BS 214 may communicate with the UE 215 in units of slots 202. The slots 202 are shown as S1, S2, . . . , S8. The BS 214 may configure the UE 215 with a plurality of potential transmission occasions 222 (e.g., PDSCH transmission occasions) in the slots 202. In other words, the BS 214 may potentially transmit a DL communication signal to the UE 215 in each of the transmission occasions 222. Accordingly, the UE 215 may monitor for a DL transmission from the BS 214 in each transmission occasion 222.

For purposes of simplifying the discussion, FIG. 2B illustrates HARQ transmissions for one HARQ process H1 212, though it will be recognized that embodiments of the present disclosure may scale to many more HARQ processes 212 (e.g., 2, 3, to 16 or more). As shown, the BS 214 transmits a scheduling grant 220a in the slot S2 202 (e.g., via a PDCCH). The scheduling grant 220a may be transmitted as a PDCCH DCI. The scheduling grant 220a indicates a schedule for a data block 230 (e.g., PDSCH data) in the slot S2 202. In some examples, the scheduling grant 220a may additionally indicate a resource (e.g., in the slot S3 202) for transmitting a HARQ feedback for the data block 230. Subsequently, the BS 214 transmits the data block 230 (e.g., via a PDSCH) according to the schedule. The data block 230 may be in the form of a transport block (TB). A TB may include an encoded media access control (MAC) layer packet data unit (PDU) including information bits. For example, the UE 215 receives and decodes the data block 230 successfully. Thus, the UE 215 transmits an ACK 240 (marked as A) to the BS 214 in the slot S3 202 to indicate a successful decoding of the data block 230.

After receiving the ACK 240, the BS 214 transmits a scheduling grant 220b to schedule the UE 215 for a new data block 232 in the slot S4 202. The scheduling grant 220b may additionally indicate a resource in the slot S5 202 for transmitting a HARQ feedback for the data block 232. For example, the UE 215 receives the data block 232 but fails to decode the data block 232. Thus, the UE 215 transmits a NACK 242 (marked as N), for example, in the slot S5 202 to indicate a reception failure of the data block 232.

Upon receiving the NACK 242, the BS 214 transmits a scheduling grant 220c to schedule the UE 215 for a retransmission of the data block 232 in the slot S6 202. The BS 214 retransmits the data block 232 in the slot S6 202. The retransmitted data block 232 is shown as 232b. In some aspects, the retransmitted data block 232b may be identical to the initial data block 232. In some aspects, the retransmitted data block 232b may carry the same information bits as the initial data block 232 but may include a different encoded version than the initial data block 232. The UE 215 fails to detect the scheduling grant 220c and thus may not transmit a ACK or NACK for the data block 232b (shown by cross symbol in the slot S7 202). When no ACK or NACK is received for the data block 232b, the BS 214 may again retransmit the data block 232. The BS 214 may retransmit the data block 232 multiple times until the UE 215 receives the data block 232 correctly or until reaching a certain retransmission limit. As can be observed from the scenario 200, DL communication errors (e.g., where the UE 215 fails to detect and/or decode a PDCCH or a PDSCH) can be corrected through HARQ retransmission.

FIG. 2C illustrates a multi-CC communication scenario 260 according to some aspects of the present disclosure. The scenario 260 may be employed by BSs such as the BSs 105 and UEs such as the UEs 115 in a network such as the network 100 for communications. In particular, the BS may configure the UE with PDCCH search spaces in multiple CCs and may activate or deactivate a PDCCH search space in a certain CC as shown in the scenario 260. In FIG. 2, the x-axis represents time in some arbitrary units and the y-axis represents frequency in some arbitrary units. For purposes of simplicity of illustration and discussion, FIG. 2 illustrates two CCs: a primary CC (PCC) 265 and a secondary CC (SCC) 266. However, it will be recognized that embodiments of the present disclosure may scale to many more CCs, for example, 3, 4, 5, 6, or more.

The PCC 265 and the SCC 266 may be in any suitable frequency range (e.g., FR1 and/or FR2). The PCC 265 may be referred to as an anchor CC and the SCC 266 is referred to as a non-anchor CC. The anchor PCC 265 may be active at all time and may handle control signaling and/or data communications. The non-anchor SCC 266 may be activated or de-activated based on needs (e.g., to improve data throughput and/or reliability). The BS may configure the UE with PDCCH search spaces in the PCC 265 and/or in the SCC 266 within a time period 268. The time period 268 includes a plurality of transmission slots 202 or transmission time intervals (TTIs) over the PCC 265 and the SCC 266. Each slot 202 may span any suitable time duration. In some instances, each slot 202 may have a duration of about 1 ms. The search spaces may define certain time-frequency resources where the BS may transmit DL control information (DCI) (e.g., carrying scheduling information). The UE may monitor the search spaces for DCI from the BS.

The BS may activate or deactivate a certain search space. At time TO, the BS activates the PDCCH search spaces in the PCC 265 (shown as active search spaces 220) and deactivates the PDCCH search spaces in the SCC 266 (shown as inactive search spaces 222). At time T1, the BS activates the search spaces in the SCC 266 as shown by the arrow 242. At time T2, the BS deactivates the search spaces in the SCC 266 as shown by the arrow 246. The activation and/or deactivation of the SCC 266 can be based on channel conditions and/or traffic loading in the PCC 265 and/or the SCC 266 and/or throughput requirements.

The BS may transmit a PDCCH signal 282 in an active search space 270 to schedule the UE for UL and/or communications. For instance, the BS may transmit a PDCCH signal 282 in the slot no 202 via the PCC 265 to schedule a PDSCH 280 communication over the PCC 265 in the slot n₁ 202 (as shown by the arrow 290). Similarly, after activating the search spaces in the SCC 266, the BS may transmit a PDCCH signal 282 in the slot n₂ 202 via the SCC 266 to schedule a PDSCH 280 communication over the SCC 266 in the slot n₂+1 202 (as shown by the arrow 294).

In some instances, the time period 268 may correspond to an on-duration of a connected mode-discontinuous reception (C-DRX) cycle. C-DRX is a power saving technique where the BS may configure the UE to cycle through sleep-awake cycles or on-off durations, where the UE is not expected to monitor for transmission from the BS during an off-duration or sleep-duration. In some other instances, the time period 268 may be a time period during a connection where C-DRX is not used. The dynamic deactivation of search spaces in certain CC may allow for power saving at the UE irrespective of whether the C-DRX is enabled for the UE.

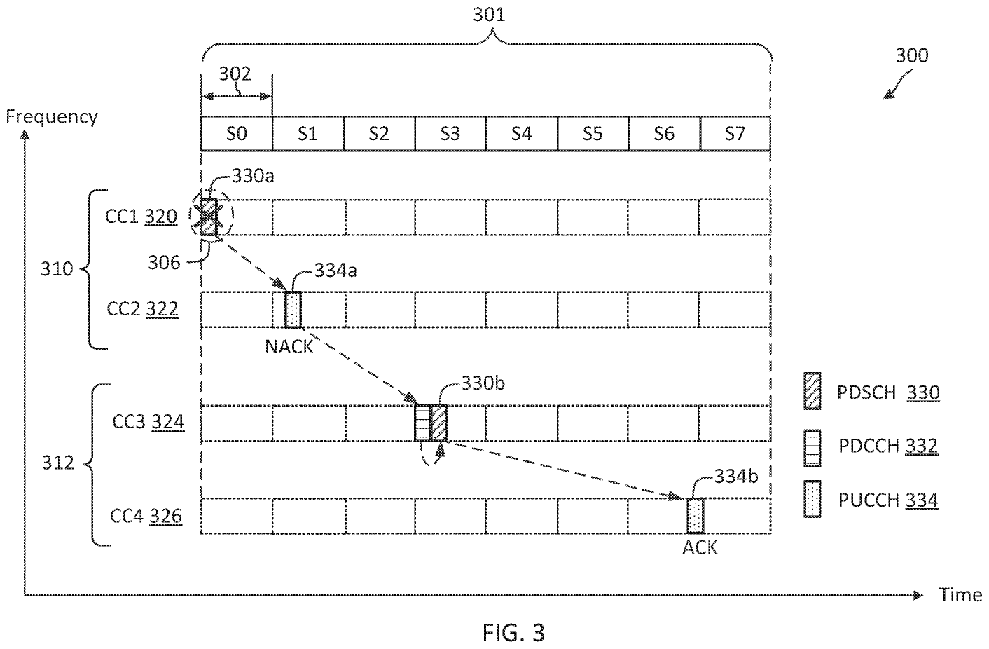

FIG. 3 illustrates a multi-CC, semi-persistent scheduling (SPS) communication scenario 300 according to some aspects of the present disclosure. The scenario 300 may be employed by BSs such as the BSs 105 and UEs such as the UEs 115 in a network such as the network 100 for communications. In particular, the BS may configure the UE with multiple CCs for communications with hybrid automatic request to provide high communication reliability as shown in the scenario 300. In FIG. 3, the x-axis represents time in some arbitrary units and the y-axis represents frequency in some arbitrary units. For purposes of simplicity of illustration and discussion, FIG. 3 illustrates two frequency bands, a frequency band 310 and a frequency band 312, and four CCs, a CC1 320 and a CC2 322 in the frequency band 310 and a CC3 324 and a CC4 326 in the frequency band 310. However, it will be recognized that embodiments of the present disclosure may scale to any suitable number of CCs (e.g., 2, 3, 5, or more) in any suitable number of frequency bands (e.g., 1, 3, 4, or more). The scenario 260 of FIG. 2C may be used in conjunction with the scenario 300 to configure, activate, and/deactivate PDCCH search spaces (e.g., the search spaces 270 and 272) in the CC1 320, CC2, 322, CC3 324, and/or CC4 326.

The frequency bands 310 and 312 may be in any suitable frequency ranges and may be configured for transmissions with any suitable subcarrier spacing (SCS). In some instances, the frequency band 310 may correspond to FR2 (e.g., between about 24 GHz to 56 GHz) and the frequency band 312 may correspond to FR1 (e.g., sub-6 GHz frequency). Transmissions in the frequency band 310 may use an SCS of about 120 kHz, whereas transmissions in the frequency band 312 may use an SCS of about 60 kHz. The BS may configure the UE with an active CC set including the CC1 320, CC2 322, CC3 324, and CC4 326 for a time period 301. The time period 301 includes a plurality transmission slots 302, which may be substantially similar to the slots 202. The time period 301 may also be referred to as a transmission cycle. The time period 301 may have any suitable duration. In some instances, the time period 301 may have a duration of about 1 ms. For purposes of simplicity of illustration and discussion, FIG. 3 illustrates eight slots 302 shown as S0 to S7. However, it will be recognized that embodiments of the present disclosure may scale to any suitable number of slots 302 (e.g., 2, 3, 4, 5, 6, 7, 9, 10 or more) or other units of time (e.g., subframes, frames, arbitrary units) in the time period 301.

In some aspects, the BS may schedule the UE with a SPS for DL data transmissions (e.g., PDSCH transmissions). The SPS may be for a certain data flow. The SPS may include a certain allocation (e.g., time-frequency resources or RBs) at a certain periodicity. The BS may determine the SPS based on a known traffic pattern for the data flow. For instance, in an industrial IOT (IIOT) scenario, an IOT device may upload measurement readings or reports to a network server at some preconfigured time. The BS may schedule SPS resources across multiple CCs to provide high communication reliability. For instance, the BS may configure the UE with periodic SPS resources in one or more of the CC1 320, CC2 322, CC3 324, and CC4 326. The UE may monitor for PDSCH transmission from the BS based on the configured SPS resources.

As shown in FIG. 3, an SPS resource 306 is configured in the CC1 320 for the slot S0 302. The BS may configure the SPS resource 306 during a previous transmission cycle or time period before the time period 301. The BS may transmit a PDSCH data block 330a to the UE in the SPS resource 306. The PDSCH data block 330a may be transmitted in the form of a TB. The transmission of the PDSCH data block 330a in the SPS resource 306 may be referred to as a configured transmission where no dynamic scheduling DCI is used for scheduling. The PDSCH data block 330a may be associated with a HARQ process.

The UE may monitor the SPS resource 306 for a PDSCH transmission from the BS based on the SPS configuration. Upon receiving the PDSCH data block 330a, the UE may provide the BS with a reception status of the PDSCH data block 330a. For example, the UE fails to decode the PDSCH data block 330a and thus may transmit a NACK to the BS. The configuration for the SPS resource 306 may indicate a resource for a corresponding ACK/NACK transmission. For instance, the ACK/NACK resource for the SPS resource 306 is located in the slot S1 302. Thus, the UE may transmit a PUCCH signal 334a in the slot S1 302 indicating the NACK for the PDSCH data block 330a. The NACK may be transmitted in the form of a UCI.

Upon receiving a NACK, the BS may schedule for a retransmission of the PDSCH data block 330a. The BS may schedule the retransmission in another CC that is more reliable than the CC used for the initial transmission. For instance, the initial transmission may be over a mmWave band which may be susceptible to signal blockage and the retransmission may over a sub-6 GHz band which may be more reliable. As shown in FIG. 2, the BS schedules the retransmission in the CC3 324 during the slot S3 302. The BS may transmit a PDCCH signal 332 in the slot S3 302 indicating the retransmission schedule (in the form of a DCI). In some aspects, the PDCCH signal 332 and retransmission schedule may be associated with a dynamic grant for downlink communications. The BS may retransmit the PDSCH data block 330a according to the retransmission schedule. The retransmission is shown as 330b. The retransmission 330b may include the same TB as the PDSCH data block 330a.

In some instances, a TB can be segmented into code block groups (CBGs) and the UE may provide individual ACK/NACK for each CBG. However, CBG segmentation may not be allowed when a retransmission is in a different CC than an initial transmission. For instance, the TB in the PDSCH data block 330a is segmented into three CBGs and the UE only failed to decode one of the CBGs. For the retransmission on the CC3 324, the BS may retransmit the entire TB instead of only the failed CBG since the UE may not know that the successfully decoded CBGs received in the CC1 320 and retransmitted CBG in the CC3 324 belong to the same TB.

The UE may monitor for the PDCCH signal 332 based on a preconfigured search space (e.g., the active search spaces 220) in the slot S3 302. Upon detecting the retransmission schedule in the PDCCH signal 332, the UE may receive the PDSCH data block 330b based on the retransmission schedule. The UE may perform demodulation and decoding to recover data in the PDSCH data block 330b. For example, the UE successfully decoded the PDSCH data block 330b. Thus, the UE may transmit a PUCCH signal 334b indicating an ACK in the slot S7 302.

In some aspects, the BS may configure an SPS resource in each of the active CC1 320, CC2 322, CC3 324, and CC4 326 and may transmit a PDSCH transmission in a most reliable CC. Thus, the UE may be required to monitor and/or demodulate all the active CC1 320, CC2 322, CC3 324, and CC4 326 to search for DL transmissions from the BS. Similarly, the UE may be required to monitor and/or demodulate all the active CC1 320, CC2 322, CC3 324, and CC4 326 to search for PDCCH decoding (e.g., DCI) since the BS may schedule a transmission in any of the active CC1 320, CC2 322, CC3 324, and CC4 326 based on channel conditions. Further, the UE may be configured with configured grants or resources for UL transmissions in one or more of the CC1 320, CC2 322, CC3 324, and CC4 326. The BS may schedule the UE with a retransmission schedule upon failing to decode a UL transmission. The UL retransmission schedule may be in any of the CC1 320, CC2 322, CC3 324, and CC4 326 similar to the DL retransmission schedule. Thus, the UE may be required to monitor all active CC1 320, CC2 322, CC3 324, and CC4 326. As such, for each DL transmission occasion including SPS resources and/or PDCCH search spaces, the UE is required to monitor and/or demodulate all the active CC1 320, CC2 322, CC3 324, and CC4 326.

Accordingly, the present disclosure provides techniques for determining a piggybacking opportunity for communicating downlink control information (DCI) in a semi-persistent scheduling (SPS) configuration. The present disclosure further provides techniques for configuring SPS retransmissions in the SPS configuration via piggybacking DCI.

FIG. 4 is a block diagram of an exemplary UE 400 according to some aspects of the present disclosure. The UE 400 may be a UE 115 discussed above in FIG. 1, for example. As shown, the UE 400 may include a processor 402, a memory 404, a SPS module 408, a transceiver 410 including a modem subsystem 412 and a radio frequency (RF) unit 414, and one or more antennas 416. These elements may be in direct or indirect communication with each other, for example via one or more buses.

The processor 402 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 402 may also be implemented as a combination of computing devices, e.g., a combination of a DSP and a microprocessor, a plurality of microprocessors, one or more microprocessors in conjunction with a DSP core, or any other such configuration.

The memory 404 may include a cache memory (e.g., a cache memory of the processor 402), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid-state memory device, hard disk drives, other forms of volatile and non-volatile memory, or a combination of different types of memory. In an embodiment, the memory 404 includes a non-transitory computer-readable medium. The memory 404 may store, or have recorded thereon, instructions 406. The instructions 406 may include instructions that, when executed by the processor 402, cause the processor 402 to perform the operations described herein with reference to the UEs 115 in connection with embodiments of the present disclosure, for example, aspects of FIGS. 2-3 and 6-10. Instructions 406 may also be referred to as program code. The program code may be for causing a wireless communication device to perform these operations, for example by causing one or more processors (such as processor 402) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The SPS module 408 may be implemented via hardware, software, or combinations thereof. For example, the SPS module 408 may be implemented as a processor, circuit, and/or instructions 406 stored in the memory 404 and executed by the processor 402. In some examples, the SPS module 408 can be integrated within the modem subsystem 412. For example, the SPS module 408 can be implemented by a combination of software components (e.g., executed by a DSP or a general processor) and hardware components (e.g., logic gates and circuitry) within the modem subsystem 412. In some examples, a UE may include one or more SPS modules 408.

The SPS module 408 may be used for various aspects of the present disclosure, for example, aspects of FIGS. 2-3 and 6-10. The SPS module 408 is configured to communicate downlink information based on a SPS configuration. The SPS module 408 is further configured to determine a piggybacking opportunity for communicating DCI in a SPS configuration. The SPS module 408 is further configured to determine HARQ processes associated with retransmitting SPS PDSCH communications. The SPS module 408 is further configured to communicate a communication, including a piggybacking DCI on a PDSCH or an ACK/NACK on a PUCCH, associated with the piggybacking opportunity. The SPS module 408 is further configured to associate one or more piggybacking opportunities with a SPS configuration based on radio resource control (RRC) information, a media access control control element (MAC-CE), or SPS activation DCI. The SPS module 408 is further configured to receive and process piggybacking DCI associated with a MAC-CE. The SPS module 408 is further configured to receive and process piggybacking DCI on a SPS PDSCH that includes, for instance, a physical uplink channel (PUCCH) resource indicator (PRI) associated with a block acknowledgement configuration for the SPS configuration.

As shown, the transceiver 410 may include the modem subsystem 412 and the RF unit 414. The transceiver 410 can be configured to communicate bi-directionally with other devices, such as the BSs 105. The modem subsystem 412 may be configured to modulate and/or encode the data from the memory 404 and/or the SPS module 408 according to a modulation and coding scheme (MCS), e.g., a low-density parity check (LDPC) coding scheme, a turbo coding scheme, a convolutional coding scheme, a digital beamforming scheme, etc. The RF unit 414 may be configured to process (e.g., perform analog to digital conversion or digital to analog conversion, etc.) modulated/encoded data (e.g., PUCCH, PUSCH, UCI, ACK/NACK, group ACK/NACK, CG uplink transmissions, channel report, SRS) from the modem subsystem 412 (on outbound transmissions) or of transmissions originating from another source such as a UE 115 or a BS 105. The RF unit 414 may be further configured to perform analog beamforming in conjunction with the digital beamforming. Although shown as integrated together in transceiver 410, the modem subsystem 412 and the RF unit 414 may be separate devices that are coupled together at the UE 115 to enable the UE 115 to communicate with other devices.

The RF unit 414 may provide the modulated and/or processed data, e.g. data packets (or, more generally, data messages that may contain one or more data packets and other information), to the antennas 416 for transmission to one or more other devices. The antennas 416 may further receive data messages transmitted from other devices. The antennas 416 may provide the received data messages for processing and/or demodulation at the transceiver 410. The transceiver 410 may provide the demodulated and decoded data (e.g., broadcast channels, DL data blocks, CC configurations, PDSCH, PDCCH, DCI, MCS, TPC, CSI-RS, ZP CSI-RS trigger, SPS configuration, SPS PDSCH, MAC-CE, group ACK codebook, dynamic grant (DG) configuration, configured grant (CG) configuration, DG PDCCH, reference signal) to the SPS module 408 for processing. The antennas 416 may include multiple antennas of similar or different designs in order to sustain multiple transmission links. The RF unit 414 may configure the antennas 416.

In an embodiment, the UE 400 can include multiple transceivers 410 implementing different RATs (e.g., NR and LTE). In an embodiment, the UE 400 can include a single transceiver 410 implementing multiple RATs (e.g., NR and LTE). In an embodiment, the transceiver 410 can include various components, where different combinations of components can implement different RATs.

FIG. 5 is a block diagram of an exemplary BS 500 according to some aspects of the present disclosure. The BS 500 may be a BS 105 as discussed above in FIG. 1, for example. As shown, the BS 500 may include a processor 502, a memory 504, a SPS module 508, a transceiver 510 including a modem subsystem 512 and a RF unit 514, and one or more antennas 516. These elements may be in direct or indirect communication with each other, for example via one or more buses.

The processor 502 may have various features as a specific-type processor. For example, these may include a CPU, a DSP, an ASIC, a controller, a FPGA device, another hardware device, a firmware device, or any combination thereof configured to perform the operations described herein. The processor 502 may also be implemented as a combination of computing devices, e.g., a combination of a DSP and a microprocessor, a plurality of microprocessors, one or more microprocessors in conjunction with a DSP core, or any other such configuration.

The memory 504 may include a cache memory (e.g., a cache memory of the processor 502), RAM, MRAM, ROM, PROM, EPROM, EEPROM, flash memory, a solid-state memory device, one or more hard disk drives, memristor-based arrays, other forms of volatile and non-volatile memory, or a combination of different types of memory. In some embodiments, the memory 504 may include a non-transitory computer-readable medium. The memory 504 may store instructions 506. The instructions 506 may include instructions that, when executed by the processor 502, cause the processor 502 to perform operations described herein, for example, aspects of FIGS. 2-3 and 6-10 and 12. Instructions 506 may also be referred to as code, which may be interpreted broadly to include any type of computer-readable statement(s) as discussed above with respect to FIG. 4.

The SPS module 508 may be implemented via hardware, software, or combinations thereof. For example, the SPS module 508 may be implemented as a processor, circuit, and/or instructions 506 stored in the memory 504 and executed by the processor 502. In some examples, the SPS module 508 can be integrated within the modem subsystem 512. For example, the SPS module 508 can be implemented by a combination of software components (e.g., executed by a DSP or a general processor) and hardware components (e.g., logic gates and circuitry) within the modem subsystem 512. In some examples, a UE may include one or more SPS modules 508.

The SPS module 508 may be used for various aspects of the present disclosure, for example, aspects of FIGS. 2-3 and 6-10. The SPS module 508 is configured to communicate downlink information based on a SPS configuration. The SPS module 508 is further configured to determine a piggybacking opportunity for communicating DCI in a SPS configuration. The SPS module 508 is further configured to determine HARQ processes associated with retransmitting SPS PDSCH communications. The SPS module 508 is further configured to communicate a communication, including a piggybacking DCI on a PDSCH or an ACK/NACK on a PUCCH, associated with the piggybacking opportunity. The SPS module 508 is further configured to associate a piggybacking opportunity with a SPS configuration based on radio resource control (RRC) information, a media access control control element (MAC-CE), or SPS activation DCI. The SPS module 508 is further configured to process and transmit piggybacking DCI associated with a MAC-CE. The SPS module 508 is further configured to process and transmit piggybacking DCI on a SPS PDSCH that includes, for instance, a physical uplink channel (PUCCH) resource indicator (PRI) associated with a block acknowledgement configuration for the SPS configuration.

As shown, the transceiver 510 may include the modem subsystem 512 and the RF unit 514. The transceiver 510 can be configured to communicate bi-directionally with other devices, such as the UEs 115 and/or 400 and/or another core network element. The modem subsystem 512 may be configured to modulate and/or encode data according to a MCS, e.g., a LDPC coding scheme, a turbo coding scheme, a convolutional coding scheme, a digital beamforming scheme, etc. The RF unit 514 may be configured to process (e.g., perform analog to digital conversion or digital to analog conversion, etc.) modulated/encoded data (e.g., broadcast channels, DL data blocks, CC configurations, PDSCH, PDCCH, DCI, MCS, TPC, CSI-RS, ZP CSI-RS trigger, SPS configuration, SPS PDSCH, MAC-CE, group ACK codebook, dynamic grant (DG) configuration, configured grant (CG) configuration, DG PDCCH, reference signal) from the modem subsystem 512 (on outbound transmissions) or of transmissions originating from another source such as a UE 115 and 400. The RF unit 514 may be further configured to perform analog beamforming in conjunction with the digital beamforming. Although shown as integrated together in transceiver 510, the modem subsystem 512 and/or the RF unit 514 may be separate devices that are coupled together at the BS 105 to enable the BS 105 to communicate with other devices.

The RF unit 514 may provide the modulated and/or processed data, e.g. data packets (or, more generally, data messages that may contain one or more data packets and other information), to the antennas 516 for transmission to one or more other devices. This may include, for example, transmission of information to complete attachment to a network and communication with a camped UE 115 or 400 according to embodiments of the present disclosure. The antennas 516 may further receive data messages transmitted from other devices and provide the received data messages for processing and/or demodulation at the transceiver 510. The transceiver 510 may provide the demodulated and decoded data (e.g., PUCCH, PUSCH, UCI, ACK/NACK, group ACK/NACK, CG uplink transmissions, channel report, SRS) to the SPS module 508 for processing. The antennas 516 may include multiple antennas of similar or different designs in order to sustain multiple transmission links.

In an embodiment, the BS 500 can include multiple transceivers 510 implementing different RATs (e.g., NR and LTE). In an embodiment, the BS 500 can include a single transceiver 510 implementing multiple RATs (e.g., NR and LTE). In an embodiment, the transceiver 510 can include various components, where different combinations of components can implement different RATs.

FIG. 6 illustrates a semi-persistent scheduling (SPS) communication scenario according to some aspects of the present disclosure. The functionality of scenario 600 can be executed by a computing device (e.g., a processor, processing circuit, and/or other suitable component) of a wireless communication device or other suitable means. In some aspects, a wireless communication device such as the UE 115, UE 215, or UE 400 may utilize one or more components, such as the processor 402, the memory 404, the SPS module 408, the transceiver 410, the modem 412, and the one or more antennas 416, to execute the steps of scenario 600. Further, a wireless communication device such as the base station (BS) 105, BS 214, or BS 500 may utilize one or more components, such as the processor 502, the memory 504, the SPS module 508, the transceiver 510, the modem 512, and the one or more antennas 516, to execute the steps of scenario 600. The scenario 600 may employ similar mechanisms as described in FIGS. 1-5 and 7-10. In FIG. 6, the x-axis represents time in some arbitrary units, and the y-axis represents frequency in some arbitrary units.

As illustrated in FIG. 6, a BS may configure a UE with SPS over PDSCH 630. The SPS may include periodic PDSCHs 630a, 630b, and 630c. The SPS PDSCHs may be periodic over a time period 603a having arbitrary units. Time period 603a may include subperiods T0, T1, . . . T7 603b having units of, for example, slot(s), subframe(s), frame(s), or arbitrary units.

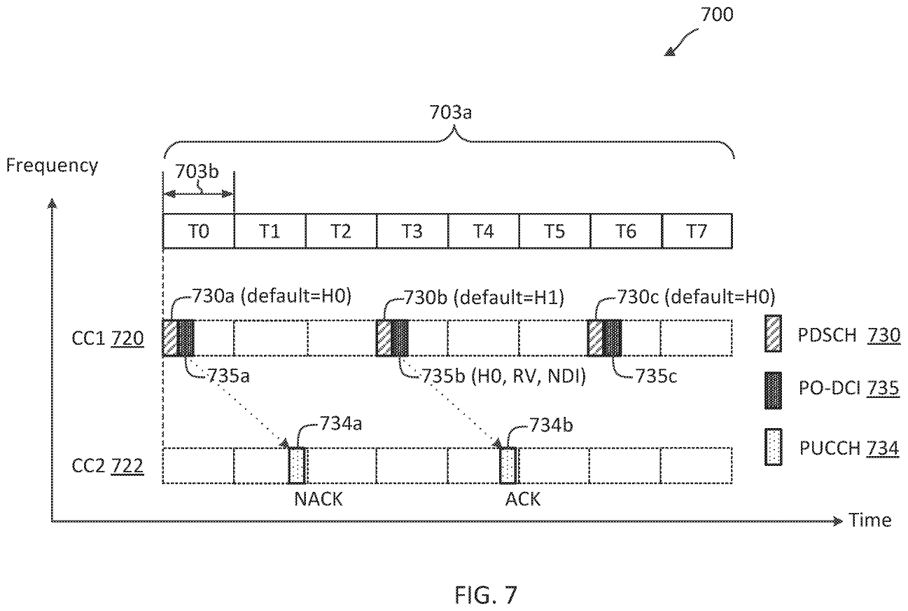

In some aspects, the component carrier CC1 620 on which the SPS PDSCHs 630 are communicated includes piggybacking opportunities for DCI (PO-DCI) 635. In some aspects, each of SPS PDSCH 630a, 630b, and 630c may include, respectively, PO-DCI 635a, 635b, and 635c piggybacked thereto on PDSCH 630. In some aspects, the piggybacked PO-DCI 635 (or PO-DCI 735, PO-DCI 835, or PO-DCI 935 of FIGS. 7-9 below) may be piggybacked to SPS PDSCH 630 by appending, attaching, concatenating, combining, inserting, puncturing, or rate matching bits. In some aspects, the piggybacked PO-DCI 635 may be piggybacked to SPS PDSCH 630 by transmitting communications PDSCH 630 and PO-DCI 635 sequentially or by transmitting PDSCH 630 and PO-DCI 635 in the same communication or message on the same CC and over the same channel (e.g., PDSCH 630). In some aspects, each of PO-DCI 635a, 635b, and 635c may comprise an opportunity in which the BS may or may not transmit DCI. In some aspects, PO-DCI 635 may be piggybacked to the beginning of PDSCH 630 such that PO-DCI 635 is communicated earlier in time than PDSCH 630. Alternatively, PO-DCI 635 may be piggybacked to the end of PDSCH 630 such that it PO-DCI 635 is communicated later in time than PDSCH 630, as illustrated in FIG. 6.

In some aspects, the semi-persistent scheduling (SPS) communication scenario of FIG. 6 (or FIGS. 7-10 below) may include configuring or activating PO-DCI 635 using a RRC message, MAC-CE, SPS activation DCI, or a combination of the foregoing communications. In some aspects, the configuration of PO-DCI 635 may override default configuration regarding communicating the associated DCI (e.g., via PDCCH). In some aspects, the UE may utilize the information included in PO-DCI 635 if the DCI are successfully decoded (e.g., based on a cyclic redundancy check (CRC)).

In some aspects, in the semi-persistent scheduling (SPS) communication scenario of FIG. 6, PO-DCI 635 (or PO-DCI 735, PO-DCI 835, or PO-DCI 935 of FIGS. 7-9 below, respectively) may include modulation and coding scheme (MCS) information regarding the MCS of the SPS configuration. In some aspects, the MSC is within a range specified by the activation DCI used to activate the SPS configuration, a RRC message, and/or a MAC-CE. In some aspects, the MCS included in PO-DCI 635 is associated with a change to the MCS or a delta MCS in order to reduce the size of or overhead associated with PO-DCI 635. In some aspects, the timing span of the MCS included in PO-DCI 635 applies to only the current SPS configuration. In some aspects, the timing span of the MCS included in PO-DCI 635 applies to the current SPS configuration and each subsequent SPS configuration until the next SPS reactivation occurs or until other notification by the BS or network. In some aspects, the timing span of the MCS included in PO-DCI 635 is based on bits or a parameter received the UE, the time-frequency resource location of PDSCH 630 (e.g., PDSCH 630a is associated with the current-SPS-configuration-only option, and PDSCH 630b is associated with the additional-SPS-configurations option), or the piggybacking technique (e.g., puncturing is associated with the current-SPS-configuration-only option, and rate matching is associated with the additional-SPS-configurations option).

In some aspects, in the semi-persistent scheduling (SPS) communication scenario of FIG. 6, PO-DCI 635 (or PO-DCI 735, PO-DCI 835, or PO-DCI 935 of FIGS. 7-9 below, respectively) may include piggybacking zero-power channel state information reference signal (ZP-CSI-RS) information. In some aspects, the piggybacked ZP-CSI-RS information includes a ZP-CSI-RS trigger indicating to the UE to avoid rate matching on resources that are carrying the CSI-RSs for other UEs. In some aspects, the SPS communication scenario includes piggybacking rate matching information with a resource block (RB) symbol-level granularity. In some aspects, piggybacking rate matching information includes two bits associated indicating rateMatchPatternGroup1 or rateMatchPatternGroup2 as defined in a 5G standard.

FIG. 7 illustrates a semi-persistent scheduling (SPS) communication scenario according to some aspects of the present disclosure. The functionality of scenario 700 can be executed by a computing device (e.g., a processor, processing circuit, and/or other suitable component) of a wireless communication device or other suitable means. In some aspects, a wireless communication device such as the UE 115, UE 215, or UE 400 may utilize one or more components, such as the processor 402, the memory 404, the SPS module 408, the transceiver 410, the modem 412, and the one or more antennas 416, to execute the steps of scenario 700. Further, a wireless communication device such as the base station (BS) 105, BS 214, or BS 500 may utilize one or more components, such as the processor 502, the memory 504, the SPS module 508, the transceiver 510, the modem 512, and the one or more antennas 516, to execute the steps of scenario 700. The scenario 700 may employ similar mechanisms as described in FIGS. 1-6 and 8-10. In FIG. 7, the x-axis represents time in some arbitrary units, and the y-axis represents frequency in some arbitrary units.

As illustrated in FIG. 7, a BS may configure a UE with SPS over PDSCH 730. The SPS may include periodic PDSCHs 730a, 730b, and 730c. The SPS PDSCHs may be periodic over a time period 703a having arbitrary units. Time period 703a may include subperiods T0, T1, . . . T7 703b having units of, for example, slot(s), subframe(s), frame(s), or arbitrary units.

In some aspects, the component carrier CC1 720 on which the SPS PDSCHs 730 are communicated includes piggybacking opportunities for DCI (PO-DCI) 735. In some aspects, each of SPS PDSCH 730a, 730b, and 730c may include, respectively, PO-DCI 735a, 735b, and 735c piggybacked thereto on PDSCH 730. In some aspects, PUCCHs 734 may be configured on the component carrier CC2 722. In some aspects, the UE may communicate ACKs and/or NACKs using PUCCHs 734.

As illustrated in FIG. 7, a BS may communicate, via PO-DCI 735, HARQ process information (e.g., HARQ control information) for retransmitting PDSCHs 730. In some aspects, PO-DCI 735 may include HARQ process information such as the HARQ process ID for one of a number of HARQ processes N having HARQ process IDs H0, H1, H2, . . . H(N−1). In some aspects, each SPS PDSCH 730 may be associated with a default HARQ process ID. For instance, PDSCH 730a is associated with default HARQ process ID H0, PDSCH 730b is associated with H1, and PDSCH 730c is associated with H0.

In some aspects, the UE may not receive PDSCH 730a, and the UE may transmit a NACK in PUCCH 734a. In some aspects, the BS may retransmit the TB or data of PDSCH 730a using PDSCH 730b, and the BS may indicate that PDSCH 730b is a retransmission by including HARQ process information (e.g., HO, RV, NDI) in PO-DCI 735b. In some aspects, PO-DCI 735 may only include information indicating the HARQ process ID of the PDSCH 730 being retransmitted (e.g., PO-DCI 730b indicates HO associated with PDSCH 730a) only when it is different from the default HARQ process ID of the PDSCH 730 used for retransmission (e.g., the default ID H1 associated with PDSCH 730b). In some aspects, a low-bit HARQ process ID may be used with PO-DCI 735. In some aspects, PO-DCI 735 may only include information indicating the RV when it is different from the default RV in a RV sequence configured for PDSCHs 730 (e.g., as illustrated in FIG. 7, PO-DCI 735b includes the RV associated with retransmission PDSCH 730b because it is different from the default RV value associated with PDSCH 730b). In some aspects, PO-DCI 735 may only include information indicating the RV when the PDSCH 730 includes a retransmission (e.g., PO-DCI 735b includes the NDI for retransmission PDSCH 730b). In some aspects, the absence of NDI in PO-DCI 735 may indicate that the associated PDSCH 730 includes new data (e.g., following ACK 734b, the BS may transmit new data PDSCH 730c and NDI is omitted from PO-DCI 735c).

In some aspects, in the semi-persistent scheduling (SPS) communication scenario of FIG. 7, PO-DCI 735 (or PO-DCI 635, PO-DCI 835, or PO-DCI 935 of FIGS. 6 and 8-9, respectively) may include piggybacking to-be-bounded information. In some aspects, the to-be-bounded information may be communicated by one or more bits indicating that the UE is to buffer the associated PDSCH 730 (i.e., the PDSCH 730 to which the PO-DCI 735 including the to-be-bounded bit is piggybacked) for HARQ combining with PDSCH(s) 730 that are received in the future. In some aspects, the BS may use dynamic-grant-based retransmission(s) to communicate the TBs that are to be HARQ combined. In some aspects, the BS may retransmit the TBs to be HARQ combined using SPS PDSCHs (e.g., retransmission as illustrated in scenario 700). In some aspects, the UE may skip providing an ACK/NACK response to the PDSCH to which the to-be-bounded bit is piggybacked, including in the absence of a group ACK configuration (e.g., a group ACK configuration allows the UE to transmit multiple ACK/NACK responses at once instead of transmitting individual ACK/NACK responses), and the UE may instead provide an ACK/NACK in response to a PDCCH or PDSCH carrying the TB to be HARQ combined with the PDSCH having the to-be-bounded bit piggybacked thereto.

In some aspects, in the semi-persistent scheduling (SPS) communication scenario of FIG. 7, PO-DCI 735 (or PO-DCI 635, PO-DCI 835, or PO-DCI 935 of FIGS. 6 and 8-9, respectively) may include downlink assignment indices (DAIs) information to provide a dynamic ACK codebook of PUCCH resources for communicating ACK/NACKs corresponding to the SPS PDSCHs 730. In some aspects, the piggybacked DAIs may apply to only the current SPS configuration. In some aspects, the piggybacked DAIs may apply to the current SPS configuration and any subsequent SPS configuration(s) until a SPS reactivation process occurs. In some aspects, the piggybacked DAIs may apply to the current SPS configuration and any dynamic grants for which an ACK/NACK can be reported within the current ACK or block ACK of the SPS configuration.

In some aspects, in the semi-persistent scheduling (SPS) communication scenario of FIG. 7, PO-DCI 735 (or PO-DCI 635, PO-DCI 835, or PO-DCI 935 of FIGS. 6 and 8-9, respectively) may include piggybacking transmit power control (TPC) information for indicating to the UE whether the uplink transmission power of a channel(s) is to be increased, decreased, or remain the same. In some aspects, the piggybacking TPC information is associated with the transmission power control of PUCCH 734. In some aspects, the piggybacking TPC information is associated with the transmission power control of an uplink sounding reference signal (SRS). In some aspects, the channel to which the TPC information included in PO-DCI 735 applies is based on bits or a parameter received the UE and/or the time-frequency resource location of PDSCH 730 (e.g., TPC information in PDSCH 730a applies to PUCCH 734, and TPC information in PDSCH 730b applies to a SRS).

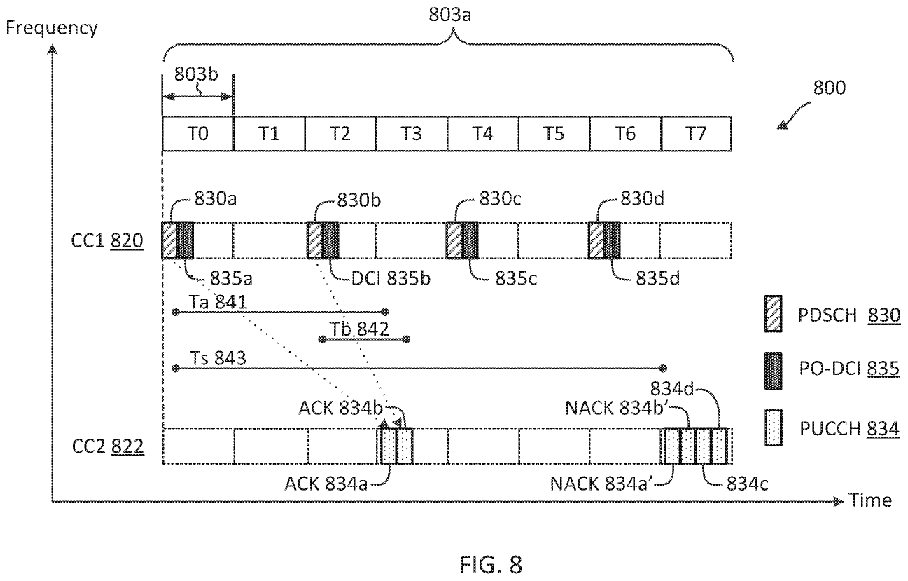

FIG. 8 illustrates a semi-persistent scheduling (SPS) communication scenario according to some aspects of the present disclosure. The functionality of scenario 800 can be executed by a computing device (e.g., a processor, processing circuit, and/or other suitable component) of a wireless communication device or other suitable means. In some aspects, a wireless communication device such as the UE 115, UE 215, or UE 400 may utilize one or more components, such as the processor 402, the memory 404, the SPS module 408, the transceiver 410, the modem 412, and the one or more antennas 416, to execute the steps of scenario 800. Further, a wireless communication device such as the base station (BS) 105, BS 214, or BS 500 may utilize one or more components, such as the processor 502, the memory 504, the SPS module 508, the transceiver 510, the modem 512, and the one or more antennas 516, to execute the steps of scenario 800. The scenario 800 may employ similar mechanisms as described in FIGS. 1-7 and 9-10. In FIG. 8, the x-axis represents time in some arbitrary units, and the y-axis represents frequency in some arbitrary units.

As illustrated in FIG. 8, a BS may configure a UE with SPS over PDSCH 830. The SPS may include periodic PDSCHs 830a, 830b, 830c, and 830d. The SPS PDSCHs may be periodic over a time period 803a having arbitrary units. Time period 803a may include subperiods T0, T1, . . . T7 803b having units of, for example, slot(s), subframe(s), frame(s), or arbitrary units.

In some aspects, the component carrier CC1 820 on which the SPS PDSCHs 830 are communicated includes piggybacking opportunities for DCI (PO-DCI) 835. In some aspects, each of SPS PDSCH 830a, 830b, 830c, and 830d may include, respectively, PO-DCI 835a, 835b, 835c, and 835d piggybacked thereto on PDSCH 830. In some aspects, PUCCHs 834 may be configured on the component carrier CC2 822. In some aspects, the UE may communicate ACKs and/or NACKs using PUCCHs 834.

As illustrated in FIG. 8, a BS may communicate a piggybacking group ACK trigger in PO-DCI 835b that requests the UE to provide prompt and/or early feedback for the UE's configured HARQ processes. In some aspects, a PDSCH 830a may be associated with a block ACK timing span Ts 843, at which time (e.g., circa the beginning of T7 803b) the UE transmits a group ACK (e.g., using PUCCH 834a′, PUCCH 834b′, PUCCH 834c, and/or PUCCH 834d). In some aspects, the original block ACK timing span Ts 843 ends at a later point in time than the prompt/early reporting timing spans Ta 841 and Tb 842 requested by the BS and associated with PDCCH 830a and PDDCH 830b, respectively. In some aspects, the UE may transmit ACK 834a and ACK 834b in a prompt/early group ACK to indicate successful reception of PDSCH 830a and PDSCH 830b, respectfully. In some aspects, in the scenario where the UE transmits ACK 834a and ACK 834b in association with PDSCH 830a and PDSCH 830b, the UE may also transmit NACK 834a′ and NACK 834b′, allowing the BS to use the HARQ processes associated with PDSCH 830a and PDSCH 830b for transmitting new data (e.g., the new data may be transmitted between the end of Tb 842 and the end of Ts 843 or after the end of Ts 843). In some aspects, the BS may transmit new data (e.g., via PDSCH(s) not shown in FIG. 8) using the HARQ processes associated with PDSCH 830a and PDSCH 830b based on receiving ACK 834a and ACK 834b. In some aspects, the group ACK including NACK 834a′ and NACK 834b′ may also include PUCCH 834c and PUCCH 834d for transmitting ACK/NACKs associated with PDSCH 830c and PDSCH 830d, respectively.

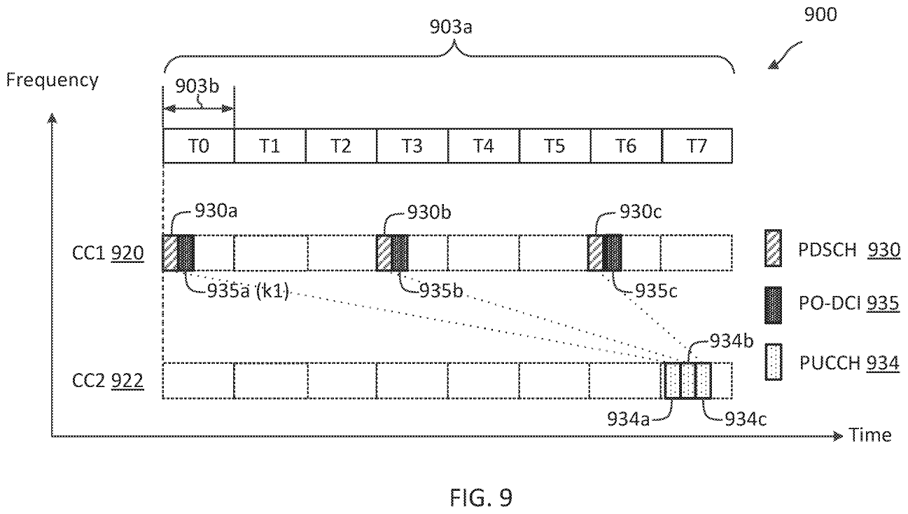

FIG. 9 illustrates a semi-persistent scheduling (SPS) communication scenario according to some aspects of the present disclosure. The functionality of scenario 900 can be executed by a computing device (e.g., a processor, processing circuit, and/or other suitable component) of a wireless communication device or other suitable means. In some aspects, a wireless communication device such as the UE 115, UE 215, or UE 400 may utilize one or more components, such as the processor 402, the memory 404, the SPS module 408, the transceiver 410, the modem 412, and the one or more antennas 416, to execute the steps of scenario 900. Further, a wireless communication device such as the base station (BS) 105, BS 214, or BS 500 may utilize one or more components, such as the processor 502, the memory 504, the SPS module 508, the transceiver 510, the modem 512, and the one or more antennas 516, to execute the steps of scenario 900. The scenario 900 may employ similar mechanisms as described in FIGS. 1-8 and 10. In FIG. 9, the x-axis represents time in some arbitrary units, and the y-axis represents frequency in some arbitrary units.

As illustrated in FIG. 9, a BS may configure a UE with SPS over PDSCH 930. The SPS may include periodic PDSCHs 930a, 930b, and 930c. The SPS PDSCHs may be periodic over a time period 903a having arbitrary units. Time period 903a may include subperiods T0, T1, . . . T7 903b having units of, for example, slot(s), subframe(s), frame(s), or arbitrary units.

In some aspects, the component carrier CC1 920 on which the SPS PDSCHs 930 are communicated includes piggybacking opportunities for DCI (PO-DCI) 935. In some aspects, each of SPS PDSCH 930a, 930b, and 930c may include, respectively, PO-DCI 935a, 935b, and 935c piggybacked thereto on PDSCH 930. In some aspects, PUCCHs 934 may be configured on the component carrier CC2 922. In some aspects, the UE may communicate ACKs and/or NACKs using PUCCHs 934.

As illustrated in FIG. 9, the BS may communicate a piggybacking PUCCH resource indicator (PRI) (also known as a k1 indicator) in PO-DCI 935a that indicates the locations of PUCCHs 934 for transmitting ACK/NACKs corresponding to PDSCHs 930. In some aspects, the piggybacking PRI 935a (k1) indicates the location of a group or block ACK for indicating ACK/NACKs in PUCCH 934a, PUCCH 934b, and PUCCH 934c associated with multiple PDSCHs 930, for example, PDSCH 930a, PDSCH 930b, and PDSCH 930c, respectively. In some aspects, the piggybacking PRI for configuring the group or block ACKs in PUCCH 934a, PUCCH 934b, and PUCCH 934c may be transmitted in PO-DCI 935b or PO-DCI 935c. In the scenario where the piggybacking PRI is communicated in PO-DCI 935, the group or block ACK for the SPS configuration may be communicated to the UE using only layer 1 (i.e., physical layer) signaling.

In some aspects, in the semi-persistent scheduling (SPS) communication scenario of FIG. 9, PO-DCI 935 (or PO-DCI 635, PO-DCI 735, or PO-DCI 835 of FIGS. 6-8, respectively) may include piggybacking radio resource allocation information for indicating to the UE a change in the time domain resource allocation (TDRA) and/or frequency domain resource allocation (FDRA) for SPS PDSCHs 930 or PUCCHs 934. In some aspects, a change in the TDRA and/or FDRA indicated via PO-DCI 935 may only apply to the current SPS configuration (e.g., the SPS configuration or the portion of the SPS configuration illustrated in period 903a). In some aspects, a change in the TDRA and/or FDRA indicated via PO-DCI 935 may apply to the current SPS configuration and any subsequent SPS configurations until the UE receives further notification from the BS.

In some aspects, in the semi-persistent scheduling (SPS) communication scenario of FIG. 9, the downlink control information communicated via PO-DCI 935 (or PO-DCI 635, PO-DCI 735, or PO-DCI 835 of FIGS. 6-8, respectively) be communicated as a MAC-CE.

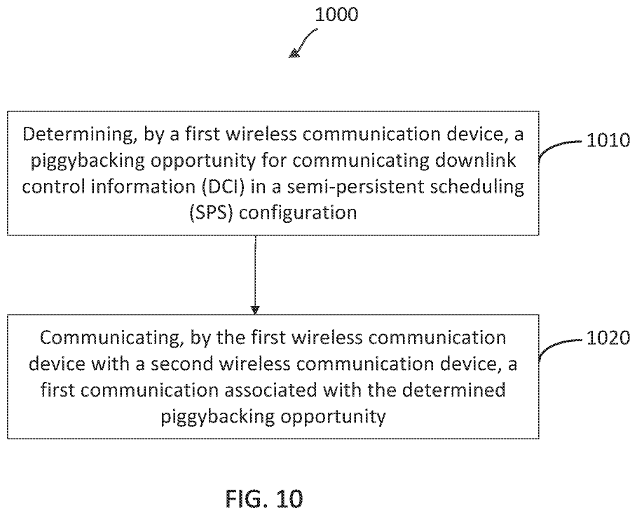

FIG. 10 illustrates a flow diagram of a communication method 1000 according to some aspects of the present disclosure. The functionality of method 1000 can be executed by a computing device (e.g., a processor, processing circuit, and/or other suitable component) of a wireless communication device or other suitable means. In some aspects, a wireless communication device such as the UE 115, UE 215, or UE 400 may utilize one or more components, such as the processor 402, the memory 404, the SPS module 408, the transceiver 410, the modem 412, and the one or more antennas 416, to execute the steps of method 1000. Further, a wireless communication device such as the base station (BS) 105, BS 214, or BS 500 may utilize one or more components, such as the processor 502, the memory 504, the SPS module 508, the transceiver 510, the modem 512, and the one or more antennas 516, to execute the steps of method 1000. The method 1000 may employ similar mechanisms as described in FIGS. 1-9.

As illustrated in FIG. 10, step 1010 includes determining, by a first wireless communication device, a piggybacking opportunity for communicating downlink control information (DCI) in a semi-persistent scheduling (SPS) configuration. In some aspects, each of network 100, BS 105 or BS 500, and UE 115 or UE 500 may perform the determining step 1010 using one or more of a processor, memory, and/or software, including, for example, the hardware and software components illustrated in FIGS. 1 and 4-5. Various algorithms may be used by each entity to perform this step, including, for example, the algorithms described above with respect to FIGS. 2A-3 and 6-9. In some aspects, the determining step 1010 may include an algorithm for determining one or more piggybacking opportunity(ies) for communicating DCI based on the algorithms of scenarios 600, 700, 800, or 900 for configuring PO-DCI 635, PO-DCI 735, PO-DCI 835, or PO-DCI 935, respectively, as discussed above and shown above in FIGS. 6-9.

Step 1020 further includes communicating, by the first wireless communication device with a second wireless communication device, a first communication associated with the determined piggybacking opportunity. In some aspects, each network 100, BS 105 or BS 500, and UE 115 or UE 500 may perform the communicating step 1020 using one or more of a processor, memory, transceiver, antenna(e), and/or software, including, for example, the hardware and software components illustrated in FIGS. 1 and 4-5. Various algorithms may be used by each entity to perform this step, including, for example, the algorithms described above with respect to FIGS. 2A-3 and 6-9.

In some instances, the determined piggybacking opportunity is based on one of radio resource control (RRC) information, a media access control control element (MAC-CE), or SPS activation DCI.

In some instances, the determined piggybacking opportunity is associated with one of a rate-matching physical downlink shared channel (PDSCH) resource or a puncturing PDSCH resource.

In some instances, the determined piggybacking opportunity overrides a default configuration for communicating DCI.

In some instances, the determined piggybacking opportunity is associated with a piggybacking modulation and coding scheme (MSC).

In some instances, the piggybacking MSC is based on one of radio resource control (RRC) information, a media access control control element (MAC-CE), or SPS activation DCI.

In some instances, the piggybacking opportunity is associated with a piggybacking opportunity timing span including one of only the SPS configuration or the SPS configuration and each of one or more subsequent SPS configurations until a reactivation procedure.

In some instances, the piggybacking opportunity timing span is based on one of a piggybacking opportunity timing span information, a time-frequency resource location, a physical downlink shared channel (PSDCH) puncturing configuration, or a PSDCH rate matching configuration.

In some instances, the determined piggybacking opportunity is associated with a piggybacking zero-power channel state information resource signal (CSI-RS) trigger for avoiding rate matching on a time-frequency resource carrying a CSI-RS.

In some instances, the determined piggybacking opportunity is associated with a resource-block symbol matching pattern, wherein the resource-block symbol matching pattern is associated with one of rateMatchPatternGroup1 or rateMatchPatternGroup2.

In some instances, the determined piggybacking opportunity is associated with a hybrid automatic repeat request (HARQ) control information (CI), wherein the HARQ CI does not include a redundancy version (RV) indicator based on a pre-configured RV sequence, wherein the HARQ CI does not include a HARQ process identifier (ID) based on a default HARQ process ID, and/or wherein the HARQ CI includes a new data indicator (NDI) based on a retransmission.

In some instances, the determined piggybacking opportunity is associated with a to-be-bounded piggybacking information for hybrid automatic repeat request (HARQ) combining a physical downlink shared channel (PDSCH) communication, wherein the PDSCH communication includes a retransmission based on one of a dynamic grant configuration or the SPS configuration, and/or wherein the determined piggybacking opportunity is not associated with a HARQ response.

In some instances, the determined piggybacking opportunity is associated with downlink assignment indices (DAIs) for a dynamic acknowledgement codebook, wherein the DAIs are associated with one of only the SPS configuration or the SPS configuration and one or more dynamic grants, and/or wherein the SPS configuration is associated with a block acknowledgment configuration.

In some instances, the determined piggybacking opportunity is associated with a piggybacking trigger for a group acknowledgment.

In some instances, a method further comprises communicating, by the first wireless communication device with a second wireless communication device, a second communication based on the piggybacking trigger, wherein the second communication is associated with one of an acknowledgement or a negative acknowledgement.

In some instances, the determined piggybacking opportunity is associated with a transmit power control (TPC) information, wherein the TPC information is associated with a second communication, wherein the second communication is associated with one of an acknowledgment associated with the SPS configuration or a sounding reference signal, and/or wherein the second communication is based on a time-frequency resource location.

In some instances, the determined piggybacking opportunity is associated with a piggybacking physical uplink control channel (PUCCH) resource indicator (PRI).

In some instances, the piggybacking PRI is associated with a block acknowledgement configuration for the SPS configuration.

In some instances, the determined piggybacking opportunity is associated with a piggybacking radio resource allocation, wherein the piggybacking radio resource allocation is associated with one of the SPS configuration or the SPS configuration and each subsequent SPS configuration.

In some instances, the determined piggybacking opportunity is associated with a media access control control element (MAC-CE).

In some instances, a method further includes receiving, by the first wireless communication device, the first communication on a physical downlink shared channel (PDSCH) associated with the determined piggybacking opportunity.

In some instances, a method further includes transmitting, by the first wireless communication device, the first communication on a physical downlink shared channel (PDSCH) associated with the determined piggybacking opportunity.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

1. A method of wireless communication, comprising:
determining, by a first wireless communication device, a piggybacking opportunity for communicating downlink control information (DCI) in a semi-persistent scheduling (SPS) configuration; and
communicating, by the first wireless communication device with a second wireless communication device, a first communication based on the determined piggybacking opportunity.

2. The method of claim 1, wherein the determined piggybacking opportunity is based on one of radio resource control (RRC) information, a media access control control element (MAC-CE), or SPS activation DCI;
wherein the determined piggybacking opportunity is associated with one of a rate-matching physical downlink shared channel (PDSCH) resource or a puncturing PDSCH resource; and
wherein the determined piggybacking opportunity overrides a default configuration for communicating DCI.

3. The method of claim 1, wherein the determined piggybacking opportunity is associated with a piggybacking modulation and coding scheme (MSC);
wherein the piggybacking MSC is associated with one of radio resource control (RRC) information, a media access control control element (MAC-CE), or SPS activation DCI;
wherein the piggybacking opportunity is associated with a piggybacking opportunity timing span including one of only the SPS configuration or the SPS configuration and each of one or more subsequent SPS configurations until a reactivation procedure; and
wherein the piggybacking opportunity timing span is based on one of a piggybacking opportunity timing span information, a time-frequency resource location, a physical downlink shared channel (PSDCH) puncturing configuration, or a PSDCH rate matching configuration.

4. The method of claim 1, wherein the determined piggybacking opportunity is associated with a piggybacking zero-power channel state information resource signal (CSI-RS) trigger for avoiding rate matching on a time-frequency resource carrying a CSI-RS.

5. The method of claim 1, wherein the determined piggybacking opportunity is associated with a resource-block symbol matching pattern, wherein the resource-block symbol matching pattern is associated with one of rateMatchPatternGroup1 or rateMatchPatternGroup2.

6. The method of claim 1, wherein the determined piggybacking opportunity is associated with a hybrid automatic repeat request (HARQ) control information (CI);
wherein the HARQ CI does not include a redundancy version (RV) indicator based on a pre-configured RV sequence;
wherein the HARQ CI does not include a HARQ process identifier (ID) based on a default HARQ process ID; and
wherein the HARQ CI includes a new data indicator (NDI) based on a retransmission.

7. The method of claim 1, wherein the determined piggybacking opportunity is associated with a to-be-bounded piggybacking information for hybrid automatic repeat request (HARQ) combining a physical downlink shared channel (PDSCH) communication;
wherein the PDSCH communication includes a retransmission based on one of a dynamic grant configuration or the SPS configuration; and
wherein the determined piggybacking opportunity is not associated with a HARQ response.

8. The method of claim 1, wherein the determined piggybacking opportunity is associated with downlink assignment indices (DAIs) for a dynamic acknowledgement codebook;
wherein the DAIs are associated with one of only the SPS configuration or the SPS configuration and one or more dynamic grants; and
wherein the SPS configuration is associated with a block acknowledgment configuration.

9. The method of claim 1, wherein the determined piggybacking opportunity is associated with a piggybacking trigger for a group acknowledgment;
and wherein the method further comprises:
communicating, by the first wireless communication device with a second wireless communication device, a second communication based on the piggybacking trigger; and
wherein the second communication is associated with one of an acknowledgement or a negative acknowledgement.

10. The method of claim 1, wherein the determined piggybacking opportunity is associated with a transmit power control (TPC) information;
wherein the TPC information is associated with a second communication;
wherein the second communication is associated with one of an acknowledgment associated with the SPS configuration or a sounding reference signal; and
wherein the second communication is based on a time-frequency resource location.

11. The method of claim 1, wherein the determined piggybacking opportunity is associated with a piggybacking physical uplink control channel (PUCCH) resource indicator (PM).

12. The method of claim 1, wherein the determined piggybacking opportunity is associated with a piggybacking physical uplink control channel (PUCCH) resource indicator (PRI); and
wherein the piggybacking PRI is associated with a block acknowledgement configuration for the SPS configuration.

13. The method of claim 1, wherein the determined piggybacking opportunity is associated with a piggybacking radio resource allocation; and
wherein the piggybacking radio resource allocation is associated with one of the SPS configuration or the SPS configuration and each subsequent SPS configuration.

14. The method of claim 1, wherein the determined piggybacking opportunity is associated with a media access control control element (MAC-CE).

15. The method of claim 1, wherein the communicating the first communication further comprises:
receiving, by the first wireless communication device, the first communication on a physical downlink shared channel (PDSCH) associated with the determined piggybacking opportunity.

16. The method of claim 1, wherein the communicating the first communication further comprises:
transmitting, by the first wireless communication device, the first communication on a physical downlink shared channel (PDSCH) associated with the determined piggybacking opportunity.

17. A first wireless communication device, comprising:
at least one processor; and
a transceiver in communication with the at least one processor, wherein the first wireless communication device is configured to:
determine a piggybacking opportunity for communicating downlink control information (DCI) in a semi-persistent scheduling (SPS) configuration; and
communicate, with a second wireless communication device, a first communication based on the determined piggybacking opportunity.

18. The first wireless communication device of claim 17, wherein the determined piggybacking opportunity is based on one of radio resource control (RRC) information, a media access control control element (MAC-CE), or SPS activation DCI;
wherein the determined piggybacking opportunity is associated with one of a rate-matching physical downlink shared channel (PDSCH) resource or a puncturing PDSCH resource; and
wherein the determined piggybacking opportunity overrides a default configuration for communicating DCI.

19. The first wireless communication device of claim 17, wherein the determined piggybacking opportunity is associated with a piggybacking modulation and coding scheme (MSC);
wherein the piggybacking MSC is associated with one of radio resource control (RRC) information, a media access control control element (MAC-CE), or SPS activation DCI;
wherein the piggybacking opportunity is associated with a piggybacking opportunity timing span including one of only the SPS configuration or the SPS configuration and each of one or more subsequent SPS configurations until a reactivation procedure; and
wherein the piggybacking opportunity timing span is based on one of a piggybacking opportunity timing span information, a time-frequency resource location, a physical downlink shared channel (PSDCH) puncturing configuration, or a PSDCH rate matching configuration.

20. The first wireless communication device of claim 17, wherein the determined piggybacking opportunity is associated with a piggybacking zero-power channel state information resource signal (CSI-RS) trigger for avoiding rate matching on a time-frequency resource carrying a CSI-RS.

21. The first wireless communication device of claim 17, wherein the determined piggybacking opportunity is associated with a resource-block symbol matching pattern, wherein the resource-block symbol matching pattern is associated with one of rateMatchPatternGroup1 or rateMatchPatternGroup2.

22. The first wireless communication device of claim 17, wherein the determined piggybacking opportunity is associated with a hybrid automatic repeat request (HARQ) control information (CI);
wherein the HARQ CI does not include a redundancy version (RV) indicator based on a pre-configured RV sequence;
wherein the HARQ CI does not include a HARQ process identifier (ID) based on a default HARQ process ID; and
wherein the HARQ CI includes a new data indicator (NDI) based on a retransmission.

23. The first wireless communication device of claim 17, wherein the determined piggybacking opportunity is associated with a to-be-bounded piggybacking information for hybrid automatic repeat request (HARQ) combining a physical downlink shared channel (PDSCH) communication;
wherein the PDSCH communication includes a retransmission based on one of a dynamic grant configuration or the SPS configuration; and
wherein the determined piggybacking opportunity is not associated with a HARQ response.

24. The first wireless communication device of claim 17, wherein the determined piggybacking opportunity is associated with downlink assignment indices (DAIs) for a dynamic acknowledgement codebook;
wherein the DAIs are associated with one of only the SPS configuration or the SPS configuration and one or more dynamic grants; and
wherein the SPS configuration is associated with a block acknowledgment configuration.

25. The first wireless communication device of claim 17, wherein the determined piggybacking opportunity is associated with a piggybacking trigger for a group acknowledgment;
and wherein the transceiver is further configured to:
communicate, with a second wireless communication device, a second communication based on the piggybacking trigger; and
wherein the second communication is associated with one of an acknowledgement or a negative acknowledgement.

26. The first wireless communication device of claim 17, wherein the determined piggybacking opportunity is associated with a transmit power control (TPC) information;
wherein the TPC information is associated with a second communication;
wherein the second communication is associated with one of an acknowledgment associated with the SPS configuration or a sounding reference signal; and
wherein the second communication is based on a time-frequency resource location.

27. The first wireless communication device of claim 17, wherein the determined piggybacking opportunity is associated with a piggybacking physical uplink control channel (PUCCH) resource indicator (PRI).

28. The first wireless communication device of claim 17, wherein the determined piggybacking opportunity is associated with a piggybacking physical uplink control channel (PUCCH) resource indicator (PRI); and
wherein the piggybacking PM is associated with a block acknowledgement configuration for the SPS configuration.

29. The first wireless communication device of claim 17, wherein the determined piggybacking opportunity is associated with a piggybacking radio resource allocation; and
wherein the piggybacking radio resource allocation is associated with one of the SPS configuration or the SPS configuration and each subsequent SPS configuration.

30. The first wireless communication device of claim 17, wherein the determined piggybacking opportunity is associated with a media access control control element (MAC-CE).

31. The first wireless communication device of claim 17, wherein the first wireless communication device is further configured to:
receive the first communication on a physical downlink shared channel (PDSCH) associated with the determined piggybacking opportunity.

32. The first wireless communication device of claim 17, wherein the first wireless communication device is further configured to:
transmit the first communication on a physical downlink shared channel (PDSCH) associated with the determined piggybacking opportunity.

33. (canceled)

34. (canceled)

35. (canceled)
